(19) United States
(12) Patent Application Publication
(10) Pub. No.: US 2009/0271268 A1
(43) Pub. Date: Oct. 29, 2009

(54) METHOD AND SYSTEM FOR PROVIDING ADVERTISEMENTS IN COMMUNICATION SERVICE

(76) Inventors: Yang Zhao, Shenzhen (CN); Qian Sun, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/499,436

(22) Filed: Jul. 8, 2009

Related U.S. Application Data
(63) Continuation of application No. PCT/CN2008/070147, filed on Jan. 21, 2008.

(30) Foreign Application Priority Data
Apr. 6, 2007 (CN) 200710100422.6

(51) Int. Cl. G06Q 30/00

(52) U.S. Cl. 705/14.49

(57) ABSTRACT

A method for providing advertisements in a communication service includes: obtaining the corresponding advertisement resource of the user in the current communication service according to the registration information of the subscribed advertisement in the process of using the communication service; and embedding the advertisement resource into the communication service. Through the method, platform, service server and system for providing advertisements in the communication service, the advertisement recipient and the advertisement endorser enjoy pleasant service experience.

This application is a continuation of International Application No. PCT/CN 2008/070147, filed on Jan. 21, 2008, which claims priority to Chinese Patent Application No. 200710100422.6, filed with the Chinese Patent Office on Apr. 06, 2007, and entitled “Method, Platform, Service Server and System for Providing Advertisements in Communication Service,” both of which are incorporated herein by reference in their entirety.

### TECHNICAL FIELD

The present invention relates to the field of communication services and, in particular, to a method and system for providing advertisements in the communication service.

### BACKGROUND

With the development of the 3G technologies and communication networks, the commercial mode of advertisements has changed.

FIG. 1 shows a structure of an advertisement presence system in the conventional art. The advertisement presence system includes a presence body, a presence server, an observation body, and a presence XML Document Management Server (XDMS), where:

The presence body is an information presence source and sends the presence information to the presence server.

The presence server is adapted to: receive subscription information from the observation body and judge the subscription result according to the subscription authorization rules preset by the subscribed presence body; receive the presence information from the presence body and process the information according to the rules (about content authorization or filtering) set by the presence body or observation body; and release the presence information to the observation body.

The observation body is adapted to subscribe to the presence information of the presence body from the presence server and receive the presence information through the presence server.

The presence information XDMS is adapted to store the authorization list and group list of the presence body, where the authorization list includes a subscription authorization list and a content authorization list.

As shown in FIG. 2, the method for releasing advertisements by using the presence information in the conventional art includes the following steps:

subscribing, by the observation body, to the presence information of the presence body from the presence server;

releasing, by the presence body, presence information and advertisement path information such as Uniform Resource Locator (URL) of the advertisement resource;

notifying, by the presence server, the presence information and advertisement path information to the observation body;

obtaining, by the observation body, the corresponding advertisement content from the advertisement server according to the advertisement path information; and

playing, by the observation body, the advertisement.

Moreover, the service operator tends to add advertisement content directly into the service data sent by the user. For example, some commodity advertisements are affixed to the e-mail body of the user.

In the process of researching the present invention, the inventor finds at least the following defects in the conventional art:

Currently, the operator provides various communication services, but is unable to integrate various services as advertisement transmission media or propagate the advertisements by using the user as an advertisement distribution source.

### SUMMARY

The present invention provides a method, platform, service server and system for providing advertisements in communication service.

A method for providing advertisements in a communication service in an embodiment of the present invention includes:

obtaining the corresponding advertisement resource in the current communication service according to the registration information on the subscribed advertisement in the process of using the communication service; and

embedding the advertisement resource into the communication service.

Another method for providing advertisements in a communication service in an embodiment of the present invention includes:

identifying the advertisement content in order for the recipient of the service data to differentiate the advertisement content from the service data; and

embedding the identified advertisement content into the communication service data.

An advertisement platform provided in an embodiment of the present invention includes:

an advertisement interface unit, adapted to receive the request of obtaining an advertisement resource; and

an advertisement control unit, adapted to select the corresponding advertisement resource of the communication service according to the registration information on the subscribed advertisement and the request received by the advertisement interface unit, and send the corresponding advertisement resource through the advertisement interface unit.

Another advertisement platform provided in an embodiment of the present invention includes:

an advertisement interface unit, adapted to receive the request of obtaining an advertisement resource, and return the data for embedding the corresponding advertisement resource into the communication service; and

an advertisement control unit, adapted to exercise control to embed the corresponding advertisement resource into the communication service according to the registration information on the subscribed advertisement and the request received by the advertisement interface unit.

A system for providing advertisements in a communication service in an embodiment of the present invention includes:

an advertisement platform, adapted to receive registration information on a subscribed advertisement of a user, select a corresponding advertisement resource and send it to a service server; and

a service server, adapted to request and obtain the advertisement resource related to the communication service from the advertisement platform, and embed the advertisement into the corresponding communication service.

Another system for providing advertisements in a communication service in an embodiment of the present invention includes:

an advertisement platform, adapted to receive the registration information on the subscribed advertisement of the user, and transfer the advertisement to the communication participant directly according to the message sent by the service server; and

a service server, adapted to send a message to the advertisement platform after receiving the service request of the user so as to instruct the advertisement platform to transfer the advertisement to the communication participant.

Another system for providing advertisements in a communication service in an embodiment of the present invention includes a service server and an advertisement platform.

The advertisement platform is adapted to: receive the registration information on the subscribed advertisement of the user, embed an advertisement resource into the received service data forwarded by the service server, and send the service data that carries the advertisement resource to the recipient; or, embed an advertisement resource into the received service data sent by the user, and send the service data that carries the advertisement resource to the service server.

Another method for providing advertisements in a communication service in an embodiment of the present invention includes:

subscribing, by the user, to an advertisement endorsement service and selecting an advertisement to be endorsed and the communication service scope in which the advertisement is applicable; and

providing the advertisement endorsed by the user to other communication participants within the communication service scope selected by the user.

### BRIEF DESCRIPTION OF THE DRAWINGS

FIG. 1 shows a structure of an advertisement presence system in the conventional art;

FIG. 2 is a flowchart of a method for releasing advertisements by using the presence information in the conventional art;

FIG. 3 shows a structure of an advertisement endorsement system in an embodiment of the present invention;

FIG. 4 is a flowchart of pushing an endorsed advertisement proactively in an embodiment of the present invention;

FIG. 5 is a flowchart of triggering a service advertisement in an embodiment of the present invention;

FIG. 6 is a flowchart of pushing an endorsed advertisement passively in an embodiment of the present invention;

FIG. 7 is a flowchart of endorsement in a presence service in an embodiment of the present invention; and

FIG. 8 is a flowchart of endorsement in a conference service in an embodiment of the present invention.

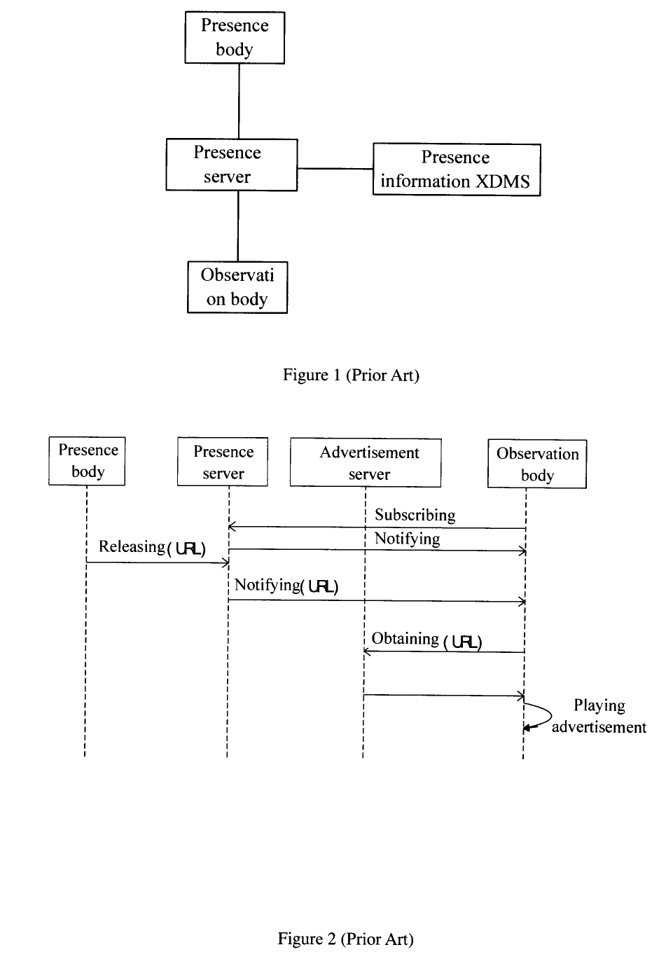

### DETAILED DESCRIPTION

A scenario of the present invention is Company C signs a contract with a mobile operator to subscribe to the advertisement service of the operator. In order to obtain a discount of tariff, a mobile subscriber named John signs a contract with the mobile operator to endorse the product of Company C, and promises to endorse the product of Company C in all or part of his mobile communication services.

John subscribes to the ring back tone service and the presence service with the mobile operator. Therefore, when John's friend calls John, the ring back tone is the advertisement of Company C; when John uses the presence service, the friend who subscribes to the presence information sees the presence information that carries the brand features of Company C from John, for example, the presence service icon of John uses the cartoon image of Company C.

The present invention is detailed below by reference to embodiments and accompanying drawings.

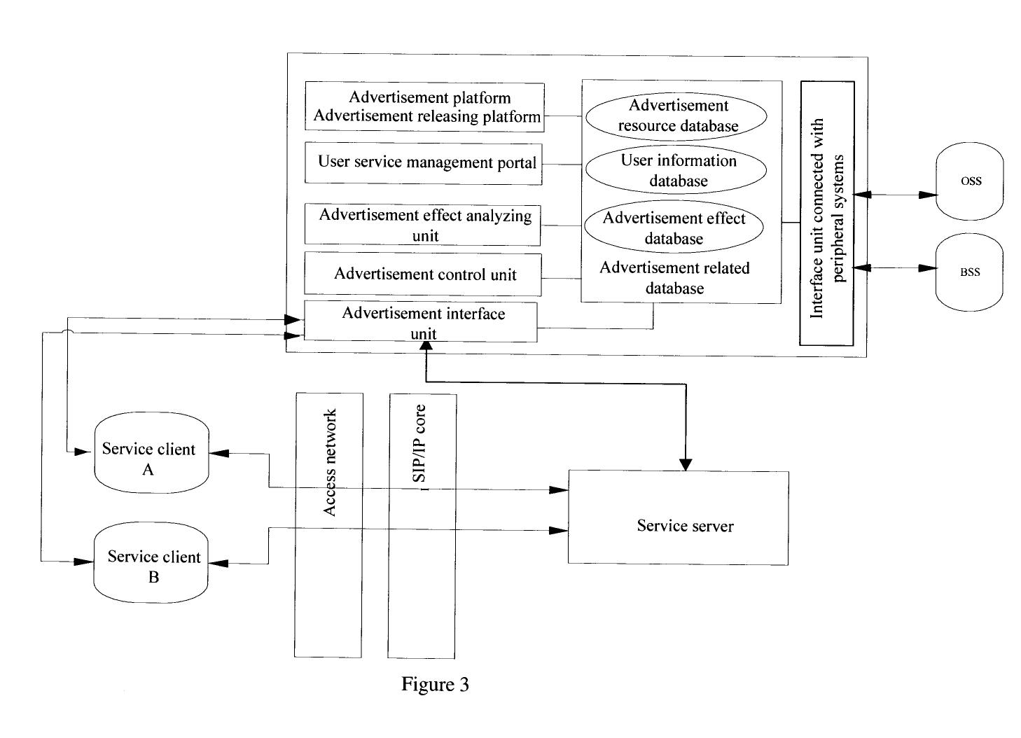

FIG. 3 shows a structure of an advertisement endorsement system in a first embodiment of the invention, where the advertisement platform is an independent public advertisement service platform of the operator, also known as an advertisement engine or advertisement server. Each telecom local network/home domain may set up an advertisement platform, and handle the advertisement service which performs session control based on a service server. The functions of an advertisement platform are to respond to the request of the service server, set up peer-to-peer sessions directly with the calling party in the communication service or the called party who goes off-hook, retrieve the advertisement resource media corresponding to the endorsement user, and play advertisements to the communication service or other participants, or return the advertisement resources corresponding to the endorsement user to the service server as requested by the service server, whereupon the service server plays advertisements to other participants of the communication service.

An advertisement platform generally includes an advertisement releasing unit, an advertisement effect analyzing unit, an advertisement related database, a user service management portal, and interface units connected with the service server and the peripheral systems, as detailed below.

The advertisement releasing unit makes and releases an advertisement resource. The released advertisement resource is stored in the advertisement related database. The released advertisement resource carries the metadata such as releaser, validity period, and type.

The advertisement effect analyzing unit receives the reported information on the advertisement application and performs advertisement effect analysis and statistics. For example, statistics are made about the state of playing a product advertisement in a specific period.

The advertisement related database includes an advertisement resource database, a user information database, and/or an advertisement effect database. Other units may store and obtain data in the advertisement related database. Generally, a system has a database similar to it, so the database is not detailed here any further.

The advertisement control unit is a core component of the advertisement platform, and is responsible for controlling selection of the communication service and providing the corresponding advertisement resources, including: selecting the advertisement resource to be pushed into the communication service, or embedding the corresponding advertisement resource into the service data directly. The advertisement control unit receives the request of obtaining the advertisement resource forwarded by the interface unit connected with the service server, and, after selecting the advertisement resource to be pushed into the communication service, returns the corresponding advertisement resource through the interface unit connected with the service server.

The user service management portal provides a user registration interface based on web interfaces and receives the registration information on the subscribed advertisement of the user. The user may subscribe to or cancel the advertisement endorsement service and configure the service scope and target user scope in which the endorsed advertisement is applicable.

The advertisement interface unit includes the interface for receiving the request of obtaining an advertisement resource sent by the user or service server, and the interface for returning the corresponding advertisement resource; or includes the interface for returning the data on the communication service which carries the embedded advertisement resource to the service server or user, or the interface for the service server to report the information on advertisement application to the advertisement platform.

The interface unit connected with peripheral systems includes the interfaces connected with the Operation Support System (OSS) and/or Business Support System (BSS).

The service server, also known as Application Server (AS), is responsible for controlling services, interacting with the advertisement platform, and intercutting advertisements. The service server may be a presence server, a Push-To-Talk over Cellular (PoC) server, an Instant Messaging (IM) server, a Short Message Service Center (SMSC), an e-mail server and/or a Multimedia Message Service Center (MMSC). A service server may include a requesting unit adapted to request and obtain the advertisement resource related to the communication service from the advertisement platform; and an embedding unit adapted to embed the advertisement resource into the corresponding communication service.

A service call initiated by the user is connected into the service server first, and the service server performs service identification and authentication and then sends a service request to the called party or the called group. In the service control, if the originating user is an advertisement endorser, the user needs to interact with the advertisement platform to obtain the relevant advertisement resource and push the advertisement to other participants in the communication service. The service server may record the advertisement propagation effectively, and report the record to the advertisement platform. For example, the service server records the user identifier of the endorsing user and other participants who receive the advertisement in the communication service, time, and advertisement type etc. For example, the user identifier may be a telephone number or Uniform Resource Locator (URL).

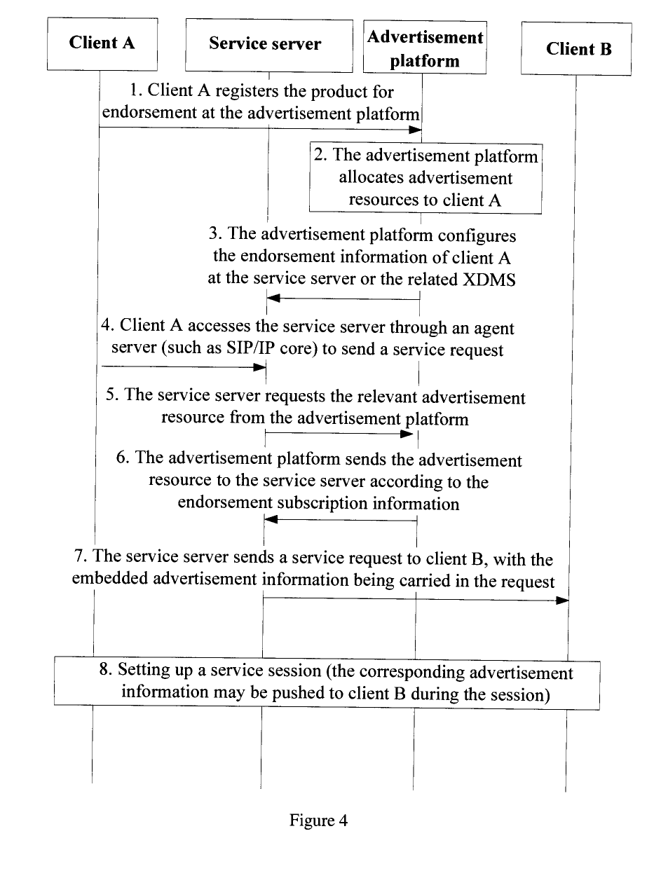

FIG. 4 is a flowchart of pushing an endorsed advertisement proactively in an embodiment of the present invention. The flowchart includes the following steps:

Step 1. User A subscribes to an advertisement endorsement service: User A registers the advertisement of a product to be endorsed on the advertisement platform. For example, endorses the product of company C and/or company N. User A may specify the service scope and target user scope in which the endorsed advertisement is applicable. The advertisement platform stores the registration information on the list of services endorsed by the user. The user subscribes to the advertisement endorsement service and specifies the specific service configuration through a user management portal of the advertisement platform, for example, specifies the service scope and target user scope in which the endorsed advertisement is applicable.

Step 2. The advertisement platform allocates the relevant advertisement resources according to the user configuration, and notifies the corresponding charging system to adjust the user's charging policy. For example, user A requests to endorse the advertisement of company C, and an operator evaluates the advertisement value of company C and allocates the corresponding tariff discount to user A.

Step 3. The advertisement platform reports the relevant registration information of user A to the relevant service server or the XML Document Management Server (XDMS) corresponding to the service server, indicating that user A has subscribed to the endorsement of the advertisement. Moreover, the advertisement platform may also transfer the information, indicating that the user has subscribed to the advertisement endorsement, Home Subscriber Server (HSS), or Home Location Register (HLR). Both HSS and HLR are central databases that store user information (for example, information on the subscribed service of the user) in the communication network, and record the information on subscription information to the advertisement endorsed by the user. Therefore, when the user performs communication services, the information on subscription to the advertisement endorsed by the user may be obtained from HSS or HLR. For example, after receiving the service request of the user, the Serving Call Session Control Function (S-CSCF) entity in the communication network adds a service feature flag into the service request according to the information on subscription to the advertisement endorsed by the user obtained from the HSS, where the flag indicates that the user has subscribed to endorsement of the advertisement. Subsequently, the service server may handle the service request according to the flag. Alternatively, if the S-CSCF discovers that the user information obtained from the HSS or HLR records the information on subscription to the advertisement endorsed by the user, and routes the service request of the user to the advertisement platform directly. The advertisement platform adds the corresponding advertisement resource and then forwards the service request to the service server or other participants of the communication service. For example, the advertisement endorser sends an instant message through a SIP MESSAGE. After receiving the message, the agent server, such as S-CSCF routes the SIP MESSAGE to the advertisement platform according to the information on subscription to the advertisement endorsed by the user (which is available from the HSS), the advertisement platform adds the advertisement content into the message, and then forwards the message to the IM server or directly to the recipient of the instant message. The operations of the advertisement platform described above may be handled by the advertisement control unit on the advertisement platform.

Step 4. User A sends a service request to user B or a user group.

Steps 5-6. The service server determines that user A has subscribed to endorsement of the advertisement, and requests to obtain the advertisement resource of the relevant service from the advertisement platform. After the advertisement to be pushed is determined according to the registration information of user A, the advertisement resource needs to be adapted as requested by the service server. For example, according to the service information such as service type in the request, the service server provides the corresponding advertisement media type (pictures, texts or sound) and the specific media parameters (size, duration, and compression rate); alternatively, the feature information such as media type and media parameter of the advertisement resource may be specified in the request directly. The advertisement resource is adapted on the advertisement platform, and the advertisement platform returns the adapted advertisement resource to the service server. If the required advertisement resource is not directly available from the advertisement platform, the existing advertisement resource may be converted to obtain the adapted advertisement resource, for example, by converting the size of the advertisement picture, sampling and compression ratio. Moreover, in the adaptation, it is necessary to consider the terminal capability of the communication participant that receives the advertisement. The foregoing user information in the request of the service server carries not only the information on the user who endorses the advertisement, but also the user information (such as telephone number or URI) of other communication participants. The service server may obtain the information on the terminal device (such as terminal model, resolution, storage capacity) from the entity that stores the user equipment information, for example, from the Device Management Server (DMS), and adapt the corresponding advertisement resource.

Step 7. The service server continues with the service request.

Step 8. The service session is created. The advertisement resource information may be applied by the service server to the session process and presented to user B.

If the advertisement endorser who initiates the service call expects to disable the advertisement endorsement service in the communication, namely, this communication does not push advertisement information to user B. For example, the sent service call request may carry a flag of disabling the advertisement endorsement service. Subsequently, according to the flag, the service server neither requests advertisement information from the advertisement platform nor pushes advertisement information to user B. Alternatively, the service server may be set to report the record of the communication that exceptionally disables the advertisement endorsement service to the relevant service charging system. The service charging system performs extra charging processing for the exceptional communication.

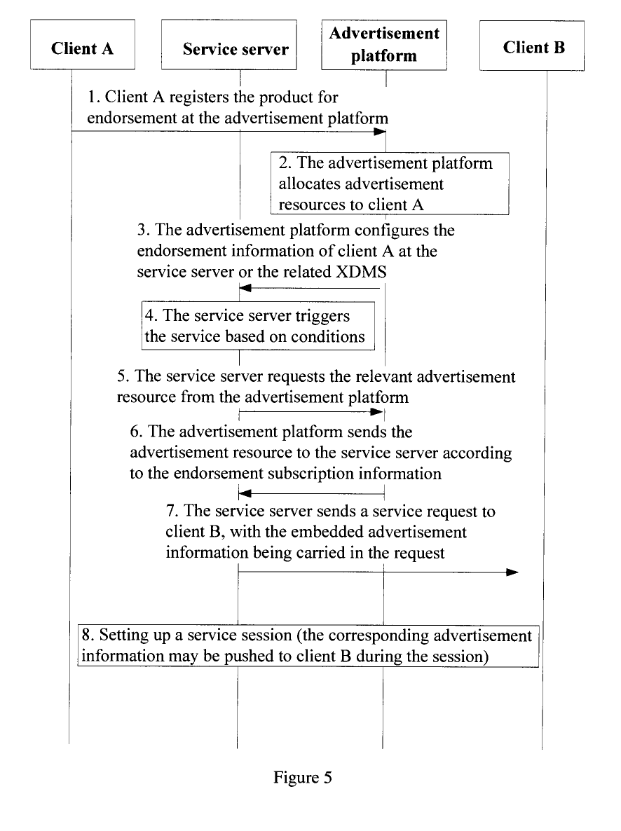

FIG. 5 is a flowchart of triggering a service advertisement in this embodiment. As shown in FIG. 5, in the foregoing step 4, the service may not only be triggered by the call initiated by user A, but also be triggered on the basis of set conditions. The set conditions may be time condition or event condition. For example, at a set time, the service server initiates a conference created by user A; or when presence information of user A changes to a set value, a notification is sent to the subscriber. Another common service scenario is that the service server sends a message preset by the user when a set condition is fulfilled. For example, at a time set, the service server sends a short message or email set by the user to other users.

When detecting that the service is triggered by set conditions, the service server needs to determine the primary user of the service and other participants. If the primary user is an advertisement endorser, the endorsed advertisement is applied and sent to other participants in the subsequent communication process. The primary user is determined according to the service type. For example, in a presence service, the primary user is the user corresponding to the presence body; in a conference service, the primary user is the creator or owner of the conference, where the conference service may be based on PoC and/or IM conference; in a message service such as SMS and Multimedia Message Service (MMS), the primary user is the sender of the message.

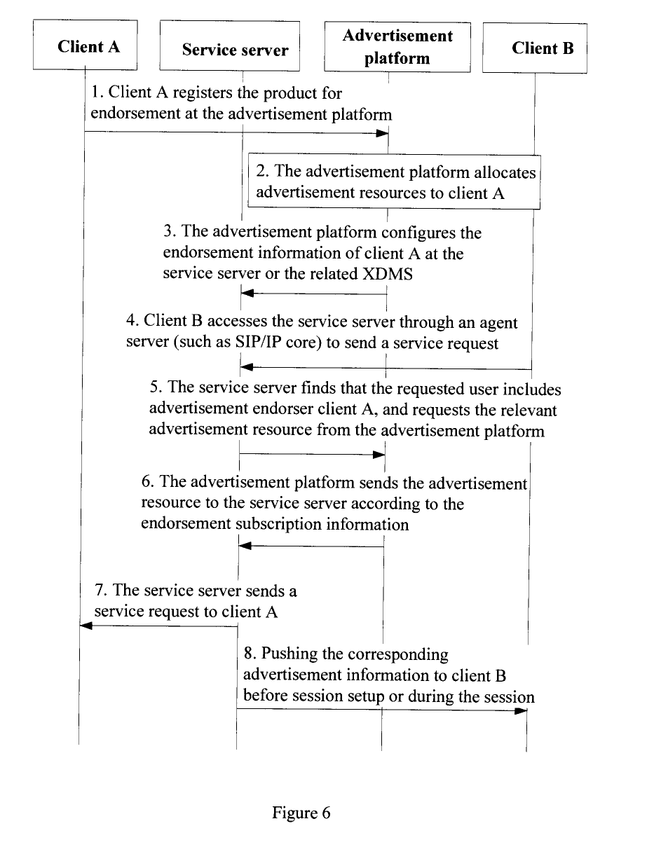

FIG. 6 is a flowchart of pushing an endorsed advertisement passively in this embodiment:

Steps 1-3 are the same as the counterpart steps of the proactive pushing process.

Step 4. User B initiates a call to user A.

Steps 5-6 are the same as the counterpart steps of the proactive pushing process.

Step 7. The service server continues with the service request.

Step 8. Before the service session is created or during the service session, the service server may push the corresponding advertisement information to user B.

When the service server obtains the advertisement resource of the relevant service from the advertisement platform, the request message of obtaining the advertisement resource sent by the service server to the advertisement platform carries the feature information of the required advertisement, user information such as identifiers of both parties to the communication, and/or service information.

The feature information of the required advertisement includes the media type and/or size, identifiers of both parties to the communication may be SIP URI or TEL URI, and the service information may be the service type and/or session identifier of the communication. The advertisement platform determines the advertisement resource information to be pushed to the service server according to the request message.

After receiving the request message of obtaining the advertisement resource, the advertisement platform records the information in the request message, including the session identifier of the communication service. After completion of the communication, the service server reports the advertisement application information (for example, time of playing the advertisement) in the communication to the advertisement platform. The reporting message carries the session identifier corresponding to the request message, and the advertisement platform may store the advertisement application information together with the information in the request message corresponding to the session identifier.

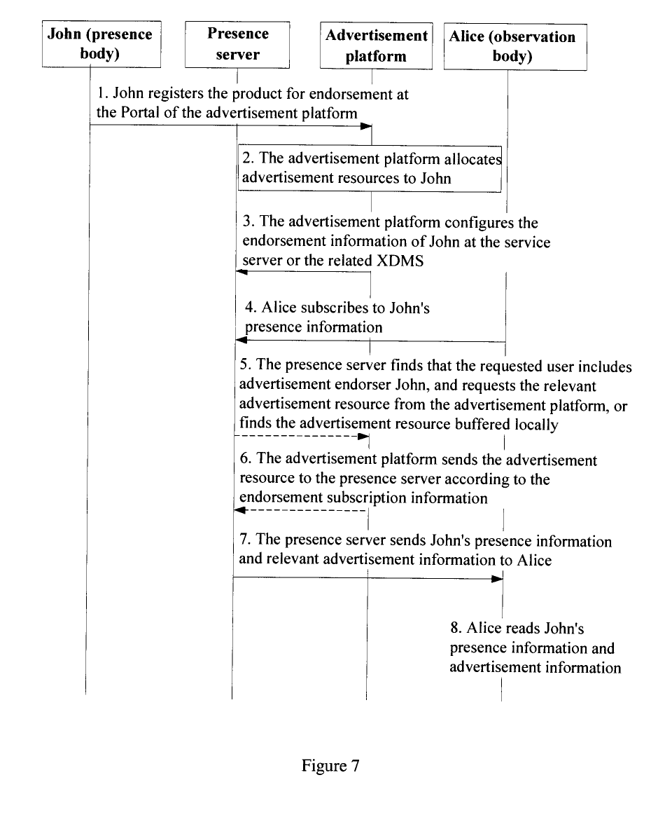

FIG. 7 shows the endorsement process of the presence service in this embodiment. John endorses the product of company H in his presence service. In the endorsement process shown in FIG. 7, John is a presence body and Alice is an observation body:

Steps 1-3: Through the interface provided by F Mobile, John chooses to subscribe to the advertisement endorsement service, and chooses to endorse the product of company H his presence service.

Step 4: John's friend Alice subscribes to the presence information of John from the presence server.

Step 5: Because the presence server has learned from the advertisement platform that John is an advertisement endorsement subscriber, the presence server requests the advertisement resource from the advertisement platform, where the request indicates the user information of advertisement endorser, requested service type and type of the relevant advertisement icon.

Step 6: The advertisement platform returns to the presence server a link of the relevant advertisement icon of company H to which John has subscribed. Steps 5 and 6 may be replaced by the following step: The advertisement platform writes the advertisement resource into John's presence information in the presence server directly. Specifically, the advertisement platform may use a SIP PUBLISH message to release the advertisement resource information, and the presence information released by the presence body John is unable to overwrite the information released by the advertisement platform. That is, the presence information that carries the advertisement resource is locked by the advertisement platform; or the advertisement platform uses an XML Configuration Access Protocol (XCAP) to release the advertisement resource to the presence server, where the advertisement resource corresponds to a presence information element. When the presence body John fails to release the presence information of the corresponding element, the advertisement resource released by the advertisement platform is used as the presence information of this element. For example, for a <note> element, if the user fails to release the presence information for it, the advertisement resource released by the advertisement platform is used as contents of the <note> element. The advertisement resource information is directly placed into the corresponding element of John's presence information. For example, the elements such as <note> and <status-icon> can bear the advertisement resource information, as exemplified below:

<status-icon>http://ad.fmobile.com/resource/huawei/presence/icon.gif</status-icon>

Step 7: The presence server may send John's presence information carrying an advertisement to Alice through a message such as SIP NOTIFY.

The advertisement may be embedded into the presence information directly. The data structure of the presence information content is illustrated in the RFC 4480 specifications of the Internet Engineering Task Force (IETF).

After Alice receives the foregoing presence information, the picture that carries the advertisement is presented as a state icon of John.

In addition, the presence information data generally carries many text information elements. A slogan may be embedded into such elements directly. For example, the MacDonald slogan is embedded into the text information elements:

<note xml:lang=“en”>MacDonald: I'm Lovin' It!</note>

The presence server may feed back the data of applying the advertisement resource information to the advertisement platform periodically, and such data is used in charging or advertisement effect analysis.

### Embodiment 2

In many services, the advertisement information needs to be inserted into the service media content. However, if the advertisement information is not differentiated from the service content, the advertisement is usually boring to the user, and the advertisement is even mistaken as a service content, which leads to perplexity or misconception. One important factor that decides the success or failure of the advertisement service applied in the communication field is user experience. When an advertisement is pushed to the recipient, technical measures may be taken to try to ensure pleasant user experience without affecting the use of normal services.

Currently, the contents of many communication services such as emails, instant messages, MMS and presence information are suitable for being provided through the Multipurpose Internet Mail Extensions (MIME) format. In this embodiment, in order to differentiate the advertisement information from the ordinary service content, a header field content purpose of MIME “Content-Purpose” is added. If an MIME content type includes a “Content-Purpose” field and the value of the field is “advertisement:”, namely, the field is “Content-Purpose: advertisement”, the MIME content type is intended for advertisement.

In the advertisement endorsement service, when the service server (such as email server and IM server) inserts advertisement resource information into the service content (such as email and instant message) to be sent to the advertisement endorser, the advertisement information may be packaged in an MIME content type whose “Content-Purpose” value is “advertisement”, and combined with the original service data content into a multipart MIME type for being sent together. According to the Content-Purpose, the recipient can identify the advertisement information, and handle the information accordingly. For example, after receiving an email that carries an advertisement, the email client of the recipient may handle the advertisement information separately and display it in an area separated from the email body. When replying to the email, the client may extract the body of the original email and include it into the reply, without carrying the advertisement information. The advertisement may include plain text information such as “Hello world!” and other advertisement contents of the media formats such as pictures, audios and videos.

Alternatively, the “Content-Disposition” header field in the MIME in the conventional art may carry an identifier that indicates its content as advertisement. For example, “Content-Disposition: advertisement” indicates that the content of the corresponding MIME body is an advertisement. This accomplishes the same purpose as the additional “Content-Purpose” header field described above.

Another method of identifying advertisement information in the MIME is to add a “Purpose” attribute into the “Content-type” field. When the value of this attribute parameter is “Advertisement”, it indicates that the media content is advertisement information.

Advertisement information may include advertisement metadata in addition to the advertisement body. The metadata indicates the type, releaser and validity period of the advertisement. The advertisement metadata may be put in the header field of the MIME body corresponding to the advertisement body, or in another MIME body on the same layer as the layer of the MIME body corresponding to the advertisement body. Moreover, the “Content-type” header field of the MIME body that contains the metadata indicates that the contents of the MIME body are advertisement metadata. For example, “Content-Type: application/ad-metadata+xml” in the header of the MIME indicates its content as advertisement metadata. The advertisement recipient may process (for example, filter) the advertisement according to the advertisement metadata.

The service server may also determine the specific content type of the MIME body corresponding to the advertisement content according to the “Content-type” of the MIME corresponding to the service data. For example, if the MIME Content-type of the service data content is “text/plain; charset=us-ascii” and the character code is “us-ascii”, the service server may obtain the advertisement resource content which has a type of “text/plain” and a character code of “us-ascii” when requesting the advertisement resource in order to ensure correct display of the advertisement at the recipient.

Through the foregoing method, the service data content may clearly specify which data is advertisement information. That is, at the time of embedding the advertisement into the service content, the advertisement is ensured to be transmitted together with the service content, and the service content is differentiated from the advertisement content effectively, thus improving service experience for the recipient. This relieves the worry of the communication operator that the advertisement service may disrupt the service experience of the user. The present invention differs from the advertisement services in the conventional art in that: the users who communicate with the endorsing user rather than the endorsing user receive the advertisement content, and the endorsing user rather than the advertisement recipient obtains the tariff discount.

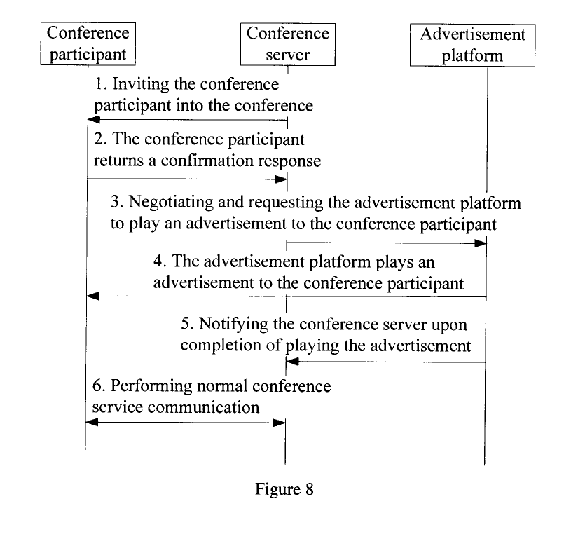

FIG. 8 is a flowchart of advertisement endorsement in a conference service in a third embodiment. The service server in this embodiment may be a conference server.

For ease of description, the process of the conference creator applying for the advertisement endorsement service is omitted here because such a process is described in embodiments 1 and 2 above. In a conference service, a conference may be initiated by the conference creator, with other conference participants being invited. Specifically, in a conference service based on SIP signaling control, the conference creator may initiate a conference through a SIP INVITE message, and the conference server sends a SIP INVITE message to other participants through a REFER message. Alternatively, for a conference with preset participants, at the time of initiating the conference, the conference server sends a SIP INVITE message to other participants automatically to invite them into the conference. The SIP INVITE message for initiating the conference may also carry a list of participants directly, and the conference server sends a SIP INVITE message to each participant in the list respectively to invite them into the conference. After the invited user confirms the intention of joining the session and returns a 200 OK response, the conference server sends to the advertisement platform a message of negotiating and requesting to play the advertisement, where the message carries the information (such as SIP URI) on the conference creator who endorses the advertisement and other participants. The advertisement platform plays the corresponding advertisement to other participants. Upon completion of playing the advertisement, the advertisement platform sends a signal to the service server to recover the normal service conversation process. Moreover, if the conference server determines that the invited user is the conference creator who subscribes to endorsement of the advertisement by judging whether the corresponding SIP URI is the same, the conference server does not notify the advertisement platform to play the advertisement. Alternatively, the advertisement platform sends the advertisement application data (for example, statistics data of playing the advertisement, and charging information) to the conference server, and the conference server integrates the normal bill records and the advertisement application data in the communication, and reports them to the charging system.

It is understandable to those skilled in the art that all or part of the steps in the foregoing embodiments may be implemented through hardware instructed by a program. The program may be stored in a computer-readable storage medium such as ROM/RAM, magnetic disk and compact disk, and the execution of such a program includes these steps: recording the registration information on subscription to advertisement endorsement of the user; in the process of using the communication service, obtaining the corresponding advertisement resource of the user in the current communication service, and embedding the advertisement resource into the communication service.

Through the method, platform, service server and system for providing advertisements in the communication service disclosed herein, in the process of using the communication service, because the user has subscribed to endorsement of an advertisement, the advertisement resource corresponding to the current communication service is embedded into the communication service according to the subscribed advertisement registration information. In this way, other users involved in the communication service can enjoy the advertisement of the endorsing user, the endorsing user serves as an advertisement distribution source, and the communication service is integrated into advertisement transmission media. Therefore, the advertisement application is broadened, and the user enjoys pleasant service experience while using the communication service.

Detailed above are a method, platform, service server and system for providing advertisements in a communication service in several embodiments of the present invention. Although the invention is described through some exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. A method for providing an advertisement in a communication service, comprising:
obtaining a corresponding advertisement resource of a user in a current communication service according to registration information on a subscribed advertisement in a process of using the communication service; and
embedding the advertisement resource into the communication service.

2. The method of claim 1, wherein before obtaining the corresponding advertisement resource of the user in the current communication service, the method further comprises:
recording the registration information on subscription to an advertisement endorsed by the user.

3. The method of claim 1, wherein the registration information comprises a target user scope, and the obtaining the corresponding advertisement resource of the user in the current communication service according to the registration information on the subscribed advertisement in the process of using the communication service comprises:
obtaining the corresponding advertisement resource of the user in the current communication service after determining that a communication service participant falls within the target user scope according to the registration information.

4. The method of claim 1, wherein the obtaining the corresponding advertisement resource of the user in the current communication service according to the registration information comprises:
determining, by an advertisement platform, the corresponding advertisement resource of the user in the current communication service according to the corresponding registration information after receiving a request message that is sent by a service server according to the subscription information.

5. The method of claim 4, further comprising:
obtaining, from a Device Management Server (DMS), terminal information of a communication participant who receives the advertisement;
adapting the advertisement resource according to the terminal information; and
sending the advertisement resource to the service server.

6. The method of claim 1, wherein the obtaining corresponding advertisement resource of the user in the current communication service in the process of using the communication service comprises:
receiving, by the advertisement platform, service data of the user sent by the service server after the service server determines that the user has subscribed to the endorsed advertisement, and obtaining the corresponding advertisement resource of the user in the current communication service according to the registration information of the advertisement.

7. The method of claim 4, further comprising:
sending, by the advertisement platform, the advertisement resource to the service server, wherein the embedding process is performed by the service server.

8. The method of claim 6, wherein the embedding comprises:
embedding, by the advertisement platform, the advertisement resource into the service data; and
sending, by the advertisement platform, the service data carrying an embedded advertisement resource to the service server.

9. The method of claim 1, wherein the user is a provider of service data in the communication service, the method further comprising receiving service data sent by the user,
wherein the obtaining comprises obtaining a corresponding advertisement resource of the user according to registration information on a subscribed advertisement resource,
wherein the embedding comprises embedding the advertisement resource into the service data; and
the method further comprising sending the service data carrying embedded advertisement resource to a service server.

10. A method for providing an advertisement in a communication service, comprising:
identifying an advertisement content in order for a recipient of service data to differentiate the advertisement content from the service data; and
embedding the identified advertisement content into the service data.

11. The method of claim 10, wherein the service data is in a Multipurpose Internet Mail Extensions (MIME) format, and the step of embedding the identified advertisement content into the service data comprises:
incorporating the advertisement content into a corresponding MIME body; and
incorporating an identifier into a header field of the MIME body corresponding to the advertisement content, wherein the identifier indicates that content of the MIME body corresponding to the advertisement content is an advertisement, and the MIME body corresponding to the service data and the MIME body corresponding to the advertisement content are incorporated in the same MIME body.

12. The method of claim 11, wherein the incorporating an identifier into the header field of the MIME body corresponding to the advertisement content comprises:
incorporating the identifier into an existing “Content-Disposition” header field of the MIME body corresponding to the advertisement content, wherein the identifier indicates that the content of the MIME body corresponding to the advertisement content is the advertisement; or
adding a new header field into an MIME type of the MIME body corresponding to the advertisement content, and incorporating the identifier into the new header field, wherein the identifier indicates that the content of the MIME body corresponding to the advertisement content is the advertisement.

13. An advertisement platform, comprising:
an advertisement interface unit adapted to receive a request of obtaining an advertisement resource; and
an advertisement control unit adapted to select the corresponding advertisement resource of a communication service according to registration information on a subscribed advertisement and the request received by the advertisement interface unit, and send the corresponding advertisement resource through the advertisement interface unit.

14. The advertisement platform of claim 13, further comprising:
an advertisement releasing unit adapted to make and release the corresponding advertisement resource in the communication service.

15. An advertisement platform, comprising:
an advertisement interface unit adapted to receive a request of obtaining an advertisement resource and return data for embedding the corresponding advertisement resource into a communication service; and
an advertisement control unit adapted to exercise control to embed the corresponding advertisement resource into the communication service according to registration information on a subscribed advertisement and the request received by the advertisement interface unit.

16. The advertisement platform of claim 15, further comprising:
a user service management portal unit adapted to receive the registration information on the subscribed advertisement of a user and output the registration information to the advertisement control unit.

17. A service server, comprising:
a requesting unit adapted to request and obtain an advertisement resource related to a communication service from an advertisement platform; and
an embedding unit adapted to embed the advertisement resource obtained by the requesting unit into the corresponding communication service.

18. A system for providing an advertisement in a communication service, comprising:
a service server and an advertisement platform,
wherein, the advertisement platform is adapted to obtain a corresponding advertisement resource of a user in the communication service according to registration information and send the advertisement resource to the service server, and
wherein the service server is adapted to request and obtain the advertisement resource related to the communication service from the advertisement platform and embed the advertisement into the corresponding communication service.

19. A system for providing an advertisement in a communication service, comprising:
a service server and an advertisement platform,
wherein the advertisement platform is adapted to obtain a corresponding advertisement resource of a user in the communication service according to a registration information, embed the advertisement resource into received service data, and send the service data that carries an advertisement resource to a recipient; and
wherein the service server is adapted to request and obtain the advertisement resource related to the communication service from the advertisement platform and receive the service data carrying the advertisement resource from the advertisement platform.

20. A computer program product comprising:
computer program code, wherein when executed by a computer unit, causes the computer unit to perform the steps of:
obtaining a corresponding advertisement resource of a user in a current communication service according to registration information on a subscribed advertisement in a process of using the communication service; and
embedding the advertisement resource into the communication service.
